(19) United States
(12) Patent Application Publication
(10) Pub. No.: US 2025/0275499 A1
(43) Pub. Date: Sep. 4, 2025

(54) LANDSCAPING APPARATUS

(71) Applicant: EMAK S.P.A., BAGNOLO IN PIANO (RE) (IT)

(72) Inventor: Gianluca BARBOLINI, MODENA (IT)

(21) Appl. No.: 18/863,753

(22) PCT Filed: May 2, 2023
(86) PCT No.: PCT/IB2023/054544

§ 371 Date: Nov. 7, 2024

(30) Foreign Application Priority Data
May 11, 2022 (IT) 102022000009680

(51) Int. Cl. A01D 34/00; A01D 101/00; A01G 3/08

(52) U.S. Cl. CPC A01D 34/008; A01G 3/086; A01D 2101/00

(57) ABSTRACT

A landscaping apparatus (1) described as comprising: a landscaping tool (10), an electronic control and command unit (25) associated with said tool and configured to detect a value of an operating parameter of the tool and/or to command the tool itself, a first transceiver (30) of the wireless type and a second transceiver (35) of the wireless type operatively connected to the electronic control and command unit (25) and fixed to a portion of the tool, a portable remote device (40) provided with an electronic control and command unit (41), a third transceiver (45) of the wireless type and a fourth transceiver (50) of the wireless type operatively connected to the control and command electronic unit (41) of the portable remote device (40) and fixed to a portion of the portable remote device (40). The first transceiver (30) and the third transceiver (45) are of the same type and have a maximum range of action lower than 0.15 m, while the second transceiver (35) and the fourth transceiver (50) are of a same type, which is different from the type of the first transceiver and the third transceiver, and have a maximum range of action higher than 0.15 m. The electronic control and command unit of the tool is configured to send a wireless signal containing an identification code of the second transceiver to the third transceiver via the first transceiver, and the electronic control and command unit of the portable remote device is configured to read said identification code and subsequently automatically establish a data connection with the electronic control and command unit of the tool via the fourth transceiver and the second transceiver.

### TECHNICAL FIELD

The present invention relates to a landscaping apparatus provided with a landscaping tool, such as chainsaws, brush cutters, hedge trimmers, blowers, lawn mowers, etc.

### PRIOR ART

It is known to wirelessly connect a portable remote device, such as a smartphone, smartband or a specially made control and diagnostic tool, to a landscaping tool in order to monitor in real time the values of certain operating parameters of the tool and/or to download, as needed, said operating parameter values to the portable remote device.

Such operating parameters may for example be the number of hours the tool has been in operation, the charge level of a supply battery of a tool motor, the number of motor revolutions, etc.

In order to establish a communication between the tool and the remote device required for data exchange, transceivers using the Bluetooth communication protocol are generally used, in particular a first Bluetooth wireless transceiver forming part of the tool or an aftermarket data acquisition device to be fixed to the tool, and a second Bluetooth wireless transceiver connected to the portable remote device (or forming part thereof). The Bluetooth communication protocol has a rather large range of action of about 10 m. In order to monitor the tool, an initial coupling of the remote device to the tool must be carried out. In order to carry out the initial coupling, the remote device performs, via the second transceiver, a scan of compatible transceivers within the range of action of the second transceiver itself, and then by means of the portable device, the user may choose which transceiver to connect to, each one corresponding to a different tool. In case a connection has already been established, the portable remote device may automatically connect to the transceiver of a tool when it enters in the range of action thereof.

The coupling, in particular the first coupling, may be a problem if the user of the portable remote device is in an environment where there is a plurality of gardening tools, possibly even of the same type, in a small space, such as a room, that can be connected to the portable remote device. Such a situation may be encountered in particular in the case of rental tool fleets, wherein several examples of a same model of landscaping tool are usually present.

In such a situation it may happen that the portable remote device is coupled to the wrong device, that time has to be wasted in attempts to couple the remote device to the right tool, that some tools may be partially shielded by the transceiver devices of other tools and end up being invisible to the portable remote device, or that in the case of automatic coupling the remote device continues to couple to a tool that is not the desired one.

An object of the present invention is to overcome the constraints of the prior art in the context of an efficient, rational and cost-effective solution. In particular, an object is to make available a landscaping apparatus that takes as little time as possible to connect to a selected tool when it is in an environment with several connectable tools.

Such object is achieved by the features of the invention reported in the independent claim. The dependent claims outline preferred and/or particularly advantageous aspects of the invention.

### DISCLOSURE OF THE INVENTION

In particular, the invention makes available a landscaping apparatus comprising:
a landscaping tool,
an electronic control and command unit associated with said tool and configured to detect a value of an operating parameter of the tool and/or to command the tool itself,
a first transceiver of the wireless type and a second transceiver of the wireless type operatively connected to the electronic control and command unit of the tool and fixed to a portion of the tool,
a portable remote device provided with an electronic control and command unit (separate from that of the tool),
a third transceiver of the wireless type and a fourth transceiver of the wireless type operatively connected to the electronic control and command unit of the portable remote device and fixed to a portion of the portable remote device
wherein the first transceiver and the third transceiver are of a same type and have a maximum range of action lower than 0.15 m,
   wherein the second transceiver and the fourth transceiver are of a same type, which is different from the type of the first transceiver and the third transceiver, and have a maximum range of action higher than 0.15 m, and wherein the electronic control and command unit of the tool is configured, via the first transceiver and the third transceiver, to send a wireless signal containing an identification code of the second transceiver to the electronic control and command unit of the portable device,
   and wherein the electronic control and command unit of the portable remote device is configured to read said identification code and then automatically establish a data connection with the electronic control and command unit of the tool via the fourth transceiver and the second transceiver.

Thanks to this solution, it is possible to avoid errors and/or time-consuming coupling between a remote portable device and a landscaping tool for monitoring/acquiring operating parameter values, as the user who wants to know these values only needs to move the remote device closer to contact or nearly-contact the selected tool. The short range of the first transceiver and the third transceiver ensures that only the tool of interest is detected and coupled to the remote device, easily, quickly and efficiently, as first wireless transceivers (i.e. short-range transceivers, e.g. NFC) of other tools present in the same environment (e.g. at a distance lower than 10 m) cannot enter the field of action of the third transceiver of the remote device when it is positioned at the selected tool, i.e. in contact or nearly in contact with it. In addition, second transceivers (i.e. transmitters with a longer range, e.g. Bluetooth) of other tools present in the same room (e.g. at a distance lower than 10 m), even if they fall within the field of action of the fourth transceiver of the remote device, do not cause any problems as the selection of the correct second transceiver is done automatically by the electronic control and command unit of the portable remote device. Furthermore, the solution set forth is particularly robust and reliable and is not affected by the dirt that generally accumulates on the tools, as the transmission of the identification code of the second transceiver occurs wirelessly.

An example of communication technology suitable for this purpose is NFC technology for the first transceiver and the third transceiver, and Bluetooth technology for the second transceiver and the fourth transceiver.

According to an aspect of the invention, the landscaping tool comprises an element for visually identifying the position of the first wireless transceiver device with respect to the tool itself.

In this it is possible to indicate to the user where he must place the third transceiver of the portable remote device in order to make the coupling, thus reducing the coupling time.

According to another aspect of the invention, the visual identification element comprises a (tool) display.

It is thereby sufficient to inform the tool user that the first wireless transceiver is located at the display, with no need to modify the casing surfaces or attach stickers on the casing to indicate the position, as the display is already a visually recognisable element of the tool.

According to a further aspect of the invention, the first wireless transceiver is installed on an electronic control and command board of the display.

It is thereby possible to reduce the footprint if compared to the case wherein the first transceiver device has its own circuit board and fewer power supply cables inside the tool, as the power supply cables of the display allow to power supply also the first transceiver. For the same reasons, it is preferable that the second transceiver is also installed on the circuit board so that it is power supplied by the same power supply cables as the display.

According to a further aspect of the invention, the electronic control and command unit may be configured to keep the first transceiver active at all times and to automatically enable a manual adjustment command, adapted to impart a command for adjusting the movement of a movable working element of the tool, when it detects the third transceiver via the first transceiver.

Thereby, at least the enabling of the manual adjustment command can be made safer than using a manual switch-on command placed on the tool, which is generally used to activate the tool, where such activation comprises enabling the manual adjustment command.

### BRIEF DESCRIPTION OF THE DRAWINGS

Further features and advantages of the invention will be more apparent after reading the following description provided by way of non-limiting example, with the aid of the figures illustrated in the accompanying drawings.

FIG. 1 is a schematic side view of an apparatus according to the invention.

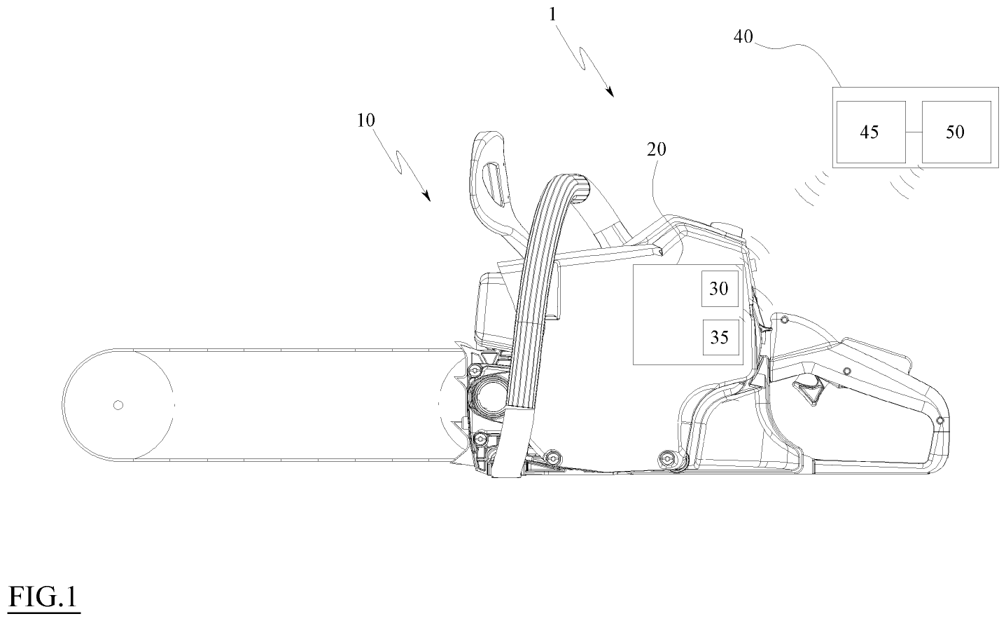

FIG. 2 is a block diagram of the apparatus according to the invention illustrated in a first operating condition.

FIG. 3 is a block diagram of the apparatus according to the invention illustrated in a second operating condition.

### BEST MODE TO IMPLEMENT THE INVENTION

With particular reference to such figures, a landscaping apparatus comprising a landscaping tool, such as a chainsaw, brush cutter, pruner, grass trimmer, shredder, walking tractor (motor cultivator, scarifier, etc.), hedge trimmer, atomiser or blower, has been referred to as 1.

For illustrative purposes only, a chainsaw 10 is shown in the figures.

The tool may comprise a motor 15, e.g. electric or endothermic.

The motor 15 is supplied by a power source, which may be a fuel tank in the case of an endothermic motor, or an electric power source in the case of an electric motor. The electric power source may in turn be a battery housed in the tool itself or a cable connecting to an electric power distribution network.

Such a motor is in particular a drive motor for a movable working element of the tool itself (an element that enables to carry out a job for which the tool is designed). Such a movable working element may be a movable cutting element, such as a chain with sharp teeth, a rotating wire or a plurality of parallel sharp teeth or rotating knives, or an impeller or fan to put pressure on a fluid (usually air).

The tool may comprise a manual switch-on command located on the tool itself (such as an on/off button).

The tool may comprise an optical interface device for displaying information for the tool user (e.g. for displaying certain operating parameters or tool settings).

Such optical interface device is fixed to a portion of the tool itself, such as a protective tool casing.

In addition, the optical interface device comprises an electronic board (not shown) contained inside the tool and power supplied either by the tool battery or by an electric generator connected to the motor (in case it is an endothermic motor).

Preferably, the optical interface device comprises a display and said electronic board, which is configured to govern the operation of the display.

Alternatively, the display may be replaced by a plurality of light signals in the form of indicator lights, such as LEDs.

The landscaping apparatus comprises an electronic control and command unit 25 configured to detect (and possibly to store in a memory and/or processing unit) a value of an operating parameter of the tool and for example to command the tool.

The operating parameter may, for example, be one of the number of hours of use, the working load of the motor, the number of motor revolutions in the unit time, i.e., the number of motor revolutions per minute (RPM), the motor oil temperature, whether the motor is on or off, the ambient temperature, the vibration intensity of the tool (possibly cross-referenced with the number of hours of use to indicate to the operator to have a break), the geographical position data of the tool, the speed at which the tool is moving, the position of the throttle valve in the case of an endothermic motor, the real-time condition of a brake between applied and not applied, the presence or absence of a cutting tool operatively connected to a motor-driven PTO, the fuel consumption in the case of an endothermic motor, the battery charge level in the case of an electric motor, the tool tilt value, the acceleration values of a drive shaft, the operating pressure, the presence of shocks, the status of the tool functions, the ambient humidity, the presence of other tools in the nearby area, the fuel level in the case of an endothermic motor.

The operating parameter is preferably an operating parameter of the motor 15 of the tool, for example such motor operating parameter is at least one of the number of hours of use, the working load of the motor, the number of motor revolutions in the unit of time, i.e. the number of motor revolutions per minute (RPM), whether the motor is on or off, the throttle valve position in the case of an endothermic motor, the battery charge level in the case of an electric motor, the acceleration values of a motor shaft.

Even more preferably, the operating parameter of the motor of the tool is at least one of whether the motor is on or off and the number of motor revolutions in the unit of time, i.e. the number of motor revolutions per minute (RPM).

The monitoring of the operating parameter by the electronic control and command unit 25 may occur either by means of a direct galvanic connection to the motor, for example because the electronic control and command unit 25 is galvanically connected to a control unit (not shown) of the motor or because the electronic control and command unit itself is also configured to control the motor 15. Alternatively, monitoring the operating parameter by the electronic control and command unit 25 may occur by means of a sensor (not shown) operatively connected to the electronic control and command unit 25 and configured to monitor wirelessly, i.e. without contact, a variable indicative of the tool operating parameter.

For example, the sensor may be one of an inductive sensor, a capacitive sensor, an acoustic sensor, a vibration sensor, or a combination of multiple types of sensors. Preferably the sensor is at least one of an inductive and a capacitive sensor. Even more preferably, the sensor is inductive.

The inductive sensor and the capacitive sensor are preferably used to measure operating parameters of the tool motor, especially the endothermic motor. As is well known, such sensors may be configured to measure (i.e. the data acquisition device may be configured to measure by means of such sensors) the electromagnetic field variations generated by the passage of the current required for generating a spark in a combustion chamber of the endothermic motor and/or the current generated by magnets in a free wheel of the endothermic motor. The electromagnetic field variations may be used to measure the number of motor revolutions in a time unit or simply to detect whether the motor is on or off.

Regarding the tool command configuration by the electronic control and command unit 25, it is understood that the electronic control and command unit 25 is configured to perform at least one of the following functions between activating the tool, deactivating the tool, and adjusting a rotation speed of a motor shaft of the tool motor or a driving torque delivered by the tool motor. Activation means a configuration wherein the working element may be placed in motion and deactivation means a configuration wherein the working element cannot be placed in motion.

For example, the tool may comprise a manual adjustment command that is configured to send signals (following manipulation by a tool user) to the electronic control and command unit, which, in response to such signals, adjusts the rotational speed of a motor shaft or the torque delivered by the motor (e.g. between zero and a maximum value). In particular, in order for the electronic control and command unit to be able to perform such adjustments, it is necessary that the tool is in the active condition, which active condition comprises enabling the electronic control and command unit to make such adjustments as a result of receiving signals from the manual adjustment command.

The electronic control and command unit 25 is associated with said tool.

For example, the electronic control and command unit 25 may be part of the tool itself or it may be part of a data acquisition device fixed to a portion of the tool itself, for example to a protective casing of the tool. If the electronic control and command unit 25 is part of a data acquisition device fixed to a portion of the tool itself, i.e. an aftermarket device, such device must comprise the sensor adapted to measure the operating parameter of the tool, in particular the motor.

In the embodiment shown, the electronic control and command unit 25 is part of the tool itself, e.g. it is configured to allow activating and deactivating the tool, as well as to allow certain motor adjustments (such as maximum power) based on signals received via user interface elements (such as levers, buttons and triggers) located on the tool itself.

The apparatus then comprises a first transceiver 30 of the wireless type and a second transceiver 35 of the wireless type operatively (e.g. galvanically) connected to the electronic control and command unit 25 and fixed to a portion of the tool.

In particular said transceivers are part of the tool and are positioned inside a portion of the tool itself, i.e. they are positioned in an inner volume defined by a tool casing. In a preferred embodiment, at least the first transceiver 30 is installed on the electronic board of the optical interface device (and is power supplied by said board). For example, the second transceiver 35 may be installed on the electronic board of the optical interface device (and be power supplied by said board).

In case the additional data acquisition device is present, the first transceiver and the second transceiver are part of said device.

The first transceiver has a maximum range of action lower than 0.15 m, and is an NFC (Near Field Communication) transceiver, i.e. it is a transceiver configured to operate according to the NFC communication protocol. NFC transceivers generally have a range of action comprised between 0 m and 0.15.

The second transceiver has a maximum range of action greater than 0.15 m, and for example is a Bluetooth transceiver, i.e. it is a transceiver configured to operate according to the Bluetooth communication protocol. Bluetooth transceivers generally have a range of action comprised between 0 m and 10 m.

The first transceiver 30 is preferably positioned at (at a maximum distance lower than 0.01 m) a visual identification element placed on the tool, such as made or positioned in a tool casing, which is intended to indicate the position of the first transceiver on the tool.

In the embodiment shown, the visual identification element corresponds with the display 20. As a matter of fact, the first transceiver is preferably installed on the display electronic board, which is generally glued or screwed or fixed by means of snap-fit hooks to a frame (framed support) of the display itself.

The apparatus then comprises a portable remote device 40, such as a smartphone or tablet or laptop computer or a purpose-built device, which is provided with its own electronic control and command unit 41 (distinct from the electronic control and command unit 25 of the tool).

The portable remote device 40 may comprise a user interface assembly (not shown), e.g. configured to allow displaying information and/or configured to enable the user to impart manual commands. In case the portable remote device is a smartphone, this user interface assembly may include a touch-screen.

The apparatus further comprises a third transceiver 45 of the wireless type and a fourth transceiver 50 of the wireless type operatively (e.g., galvanically) connected to the electronic control and command unit 41, e.g., fixed to a portion of the portable remote device.

In particular, said transceivers are part of the portable remote device and are placed inside an outer shell of the portable remote device.

The third transceiver 45 is of the same type as the first transceiver 30. In particular, the third transceiver has a maximum range of action lower than 0.15 m, and is an NFC (Near Field Communication) transceiver, i.e. it is a transceiver configured to operate according to the NFC communication protocol.

The fourth transceiver 50 is of the same type as the second transceiver 35. In particular, the fourth transceiver has a maximum range of action higher than 0.15 m, and is for example a Bluetooth transceiver, i.e. it is a transceiver configured to operate according to the Bluetooth communication protocol.

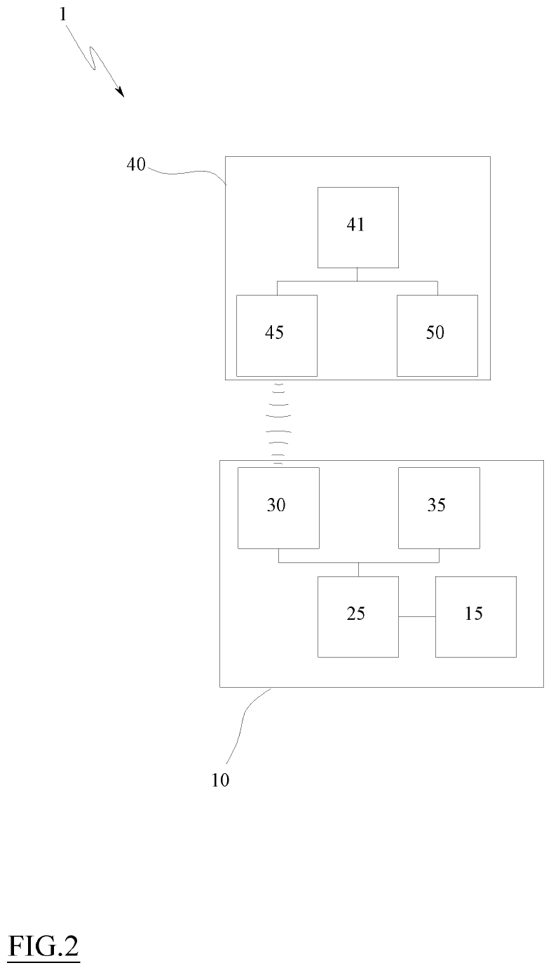

The electronic control and command unit 25 of the tool is configured to send to the third transceiver 45, via the first transceiver 30, a wireless signal containing an identification code of the second transceiver 35, i.e. a computer code identifying a connection address of the second transceiver 35 (such operating condition of the apparatus is schematically represented in FIG. 2).

Such code is unique and pre-set, e.g. also non-variable. In detail, since the technology of the second transceiver is Bluetooth, such code is the Bluetooth UUID (Universally unique identifier) of the second transceiver.

The electronic control and command unit 41 of the portable remote device is configured to read said identification code and then automatically establish a data connection with the tool electronic control and command unit 25 (only) via the fourth transceiver 50 and the second transceiver 35.

In order to automatically establish said connection, the electronic control and command unit 41 may be configured to:
scan the identification codes of (compatible) transceivers present within a range of action of the fourth transceiver through the fourth transceiver 50,
subsequently establish via the fourth transceiver 50 a connection with a transceiver, from among those obtained by scanning, whose identification code corresponds to the identified code of the second transceiver 35.

Substantially, the electronic control and command unit 41 scans, via the fourth transceiver, the available transceiver devices (within its range of action) and connects to the transceiver whose identification code (i.e. name) corresponds to the identification code (i.e. name) previously sent to it by the electronic control and command unit 25 via the first transceiver 30.

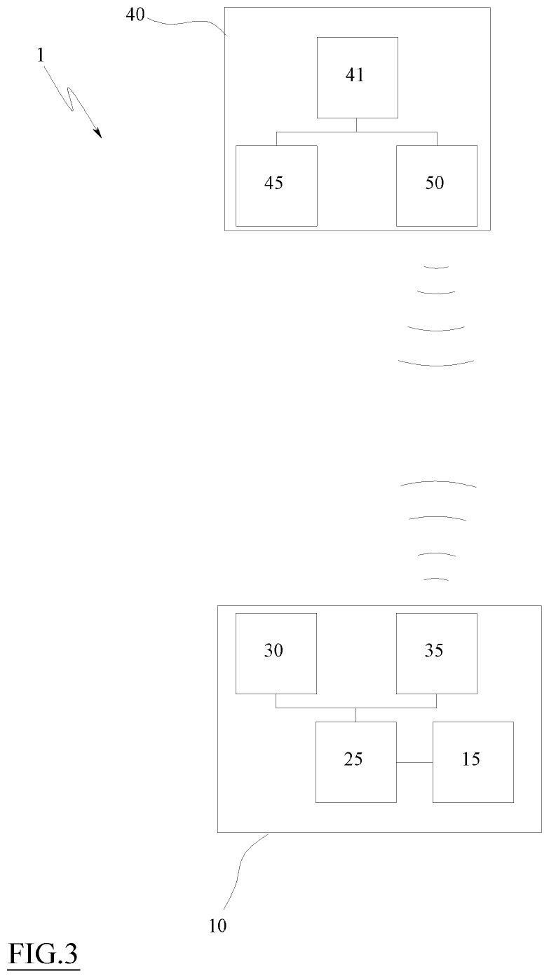

Once the connection is established, the electronic control and command unit 25 and the electronic control and command unit 41 exchange wireless signals (i.e. they communicate with each other) via the second transceiver 35 and the fourth transceiver 50 (and not via the first transceiver and the third transceiver), such as to monitor the value of the operating parameter of the tool via the remote portable device or to download the values of the operating parameter to the remote portable device or to send a command to the tool via the remote portable device (such operating condition of the apparatus is schematically represented in FIG. 3).

In other words, the first transceiver 30 and the third transceiver 35 are only used to, respectively, send the wireless signal containing the identification code of the second transceiver and receive said wireless signal containing the identification code. Subsequently, such two transceivers are not used for communicating operating parameter values.

After receiving an activation signal, for example sent via a remote device or via a user interface element placed on the tool itself, the electronic control and command unit 25 may be configured to activate the first transceiver and to cyclically send the wireless signal containing the identification code of the second transceiver via the first transceiver itself, for example for a pre-set time interval (i.e. not forever). Alternatively or additionally, the electronic control and command unit 25 may be configured to activate (power) the first transceiver (for a pre-set time interval from receipt of the activation signal) and to send said wireless signal only when it detects, via the first transceiver, the presence of the third transceiver.

It is possible to install on the portable remote device, on a memory unit thereof, a software which, when executed by the electronic control and command unit 41, allows to interface with the tool via the transceivers, in particular via the second and fourth transceivers, in order to acquire the values of the monitored operating parameter (instantaneous values, or stored in the memory or processed and stored in the memory) and/or to command the tool (for example, by activating or deactivating it or adjusting some parameters such as the rotation speed of the motor or the drive torque delivered by it).

In all the embodiments, i.e. configurations, of the electronic control and command unit of the tool described above, it is also possible to provide that also said electronic control and command unit is operatively connected to the manual switch-on command and that, following an activation signal received from said manual switch-on command, the electronic control and command unit of the tool is configured to (at least to) activate the first transceiver and the second transceiver.

It should be specified that in order to activate the first transceiver and the second transceiver they are meant to be brought into a condition wherein they are electrically supplied and wherein they may interact with compatible transceivers (i.e. using the same communication protocols).

In addition, after receiving the activation signal, the electronic control and command unit may also be configured to enable the adjustment manual command. Without such enablement, any signals sent by the manual adjustment command are ignored by the electronic control and command unit of the tool (as a result, the working element cannot be set in motion, as it can be set in motion only as a result of the user manipulating the manual adjustment command). Said enablement may be comprised in (i.e. be part of various actions comprised in) or correspond to the tool activation described above.

It may also be provided that after receiving a switch-off signal sent by the manual switch-on command, or after a predetermined time interval (of inactivity of the tool, e.g. from a last activation of the working element), the electronic control and command unit may be configured to bring the first transceiver and the second transceiver into an inactive condition (e.g. also to disable the manual adjustment command).

Said disablement may be comprised in (i.e. be part of various actions comprised in) or correspond to the tool deactivation described above.

As an alternative to such activation/switch-off configurations, it is possible to provide that the electronic control and command unit of the tool may be configured to keep the first transceiver in an active condition at all times, in particular independently of switch-off signals sent via the manual switch-on command on the tool and/or of inactivity time intervals. In such a case, the electronic control and command unit of the tool may be configured to automatically activate the second transceiver and/or automatically enable the manual adjustment command when it detects the third transceiver, via the first transceiver, or when it detects the presence of the third transceiver, via the first transceiver, within the maximum distance range of the first transceiver (in addition, it may also be provided that the display switches on automatically when, via the first transceiver, it detects the third transceiver).

Such features further improve the safety in using the tool, as the activation of the second transceiver and/or the enabling of the manual adjustment command must be performed by bringing the portable remote device closer to the tool within the maximum distance range of the first transceiver.

Additional safety logic may also be applied to such configuration wherein the first transceiver is kept active by the electronic control and command unit. For example, the electronic control and command unit of the tool may also be configured to automatically activate the second transceiver and/or automatically enable the manual adjustment command when it detects the third transceiver via the first transceiver and if, within a predetermined time interval from the detection of the third transceiver, it receives a predetermined authorisation signal containing a specific identification code (unique, different for each portable remote device) sent by the portable remote device (i.e. by the electronic control and command unit of the portable remote device) via the third transceiver.

Such an identification code may be indicative of a specific identity, e.g. the user of the tool or the portable remote device.

Furthermore, the electronic control and command unit of the tool may be configured to compare the identification code sent by the portable remote device with a plurality of pre-set codes stored in a memory unit operatively connected to the electronic control and command unit, and to automatically activate the second transceiver and/or automatically enable the manual adjustment command when it detects the third transceiver, via the first transceiver, and if, within a predetermined time interval from the detection of the third transceiver, it receives a predetermined authorisation signal containing a specific identification code (unique, different for each portable remote device) sent by the portable remote device (i.e. by the electronic control and command unit of the portable remote device) via the third transceiver, and if said detected identification code corresponds to one of the codes present in the memory unit.

The operation of the apparatus according to the invention is as follows.

When the user of the apparatus intends to couple the portable remote device to a specific landscaping tool, e.g. to monitor or download the values of at least one operating parameter or to command the tool, it is sufficient for him to move the portable remote device, in particular a portion thereof containing the third transceiver, closer to contact or nearly contact (or in any case at a distance lower than 0.1-0.15 m) the portion of the tool comprising the visual identification element, i.e. the tool display 20. When the first transceiver and the third transceiver are sufficiently close and each is within the range of action of the other, the third transceiver receives the identification code of the second transceiver from the first transceiver.

For example, before moving the portable remote device closer, the user may be asked to bring the tool into an active condition, e.g. by acting on the manual command located on the tool itself (e.g. the activation/switch-on button), so that the electronic control and command unit 25 is enabled to send the identification code of the second transceiver. The electronic control and command unit 41 uses the identification code received to find the transceiver corresponding to the identification code of the second transceiver from a list of transceivers scanned by the fourth transceiver, or to find the second transceiver from a list of transceivers scanned by the fourth transceiver.

Once the second transceiver has been found, the electronic control and command unit 41 automatically establishes the connection between the fourth transceiver and the second transceiver, and from then on the user can monitor and/or command the tool via the portable remote device.

Furthermore, as the electronic control and command unit 41 has received the identification code of the second transceiver, the user may move the portable remote device away from the tool, i.e. at a distance greater than the maximum range of distance of the first transceiver, while remaining within the maximum range of the second and fourth transceivers. The invention thus conceived is susceptible to several modifications and variations, all falling within the scope of the inventive concept.

Moreover, all details can be replaced by other technically equivalent elements. In practice, the materials used, as well as the contingent shapes and sizes, can be whatever according to the requirements without for this reason departing from the scope of protection of the following claims.

1. A landscaping apparatus comprising:
a landscaping tool,
an electronic control and command unit-associated with said tool and configured to detect a value of an operating parameter of the tool and/or to command the tool itself,
a first transceiver of the wireless type and a second transceiver of the wireless type operatively connected to the electronic control and command unit and fixed to a portion of the tool,
a portable remote device provided with an electronic control and command unit,
a third transceiver of the wireless type and a fourth transceiver of the wireless type operatively connected to the electronic control and command unit of the portable remote device and fixed to a portion of the portable remote device,
wherein the first transceiver and the third transceiver are of a same type and have a maximum range of action lower than 0.15 m, wherein the second transceiver and the fourth transceiver are of a same type, which is different from the type of the first transceiver and third transceiver, and have a maximum range of action higher than 0.15 m,
and wherein the electronic control and command unit of the tool is configured to send a wireless signal containing an identification code of the second transceiver to the third transceiver via the first transceiver,
and wherein the electronic control and command unit of the portable remote device is configured to read said identification code and then automatically establish a data connection with the electronic control and command unit of the tool via the fourth transceiver and the second transceiver.

2. The landscaping apparatus according to claim 1, wherein the first transceiver and the third transceiver are of the NFC type.

3. The landscaping apparatus according to claim 1, wherein the second transceiver and the fourth transceiver are of the Bluetooth type.

4. The landscaping apparatus according to claim 1, wherein the landscaping tool comprises a visual identification element of the position of the first wireless transceiver device with respect to the tool itself.

5. The landscaping apparatus according to claim 4, wherein the visual identification element comprises a display.

6. The landscaping apparatus according to claim 5, wherein the first transceiver is installed on an electronic control and command board of the display.

7. The landscaping apparatus according to claim 1, wherein the electronic control and command unit is configured to keep the first transceiver active at all times and to automatically enable a manual adjustment command when it detects the third transceiver via the first transceiver, said manual adjustment command being configured to send signals, following manipulation by a tool user, to the electronic control and command unit, which, in response to such signals, adjusts the rotational speed of a motor shaft or the torque delivered by the motor tool.

8. The landscaping apparatus according to claim 1, wherein after receiving an activation signal, sent via a remote device or via a user interface element placed on the tool itself, the electronic control and command unit is configured to activate the first transceiver and to cyclically send the wireless signal containing the identification code of the second transceiver via the first transceiver itself.
